(19) United States
(12) Patent Application Publication
(10) Pub. No.: US 2021/0300526 A1
(43) Pub. Date: Sep. 30, 2021

(54) Feedback mechanism and circuit design for flight control boost actuators

(71) Applicant: Plasecki Aircraft Corporation, Essington, PA (US)

(72) Inventor: Luigi U. Ricci Moretti, Swarthmore, PA (US)

(73) Assignee: Plasecki Aircraft Corporation, Essington, PA (US)

(21) Appl. No.: 16/873,559

(22) Filed: May 4, 2020

Related U.S. Application Data
(60) Provisional application No. 63/100,750, filed on Mar. 31, 2020.

(51) Int. Cl. B64C 13/50

(52) U.S. Cl. CPC B64C 13/507; B64C 13/503

(57) ABSTRACT

Safer, redundant electromechanical flight control boost actuators for aircraft, having simple feedback mechanism independent of fly-by-wire systems are described herein.

Said redundancy is achieved by two independent electric motors' systems and dual feedback mechanism.

This application is continuation of prior Provisional Patent of Luigi R. Moretti No. 63/100,758 filed on Mar. 30, 2020 and entitled “Feedback Mechanism and Circuit Design for Flight Control Boost Actuators”.

### BACKGROUND OF THE INVENTION

### Field of the Invention

This invention relates mostly to flight control boost actuators for helicopters and other aircraft.

### Description of Prior Art

It has been recognized that there is a need for safer electric flight control actuators in aircraft, and also a need for having flight control actuators functioning as boosters, amplifying the flight controls of the pilot's input, while having a simple feedback mechanism, not dependent on complex and expensive full fly-by-wire (FBW) system.

Prior art actuators or control boost mechanisms are mostly hydraulically driven, which creates complexity and thus potential failures, and added weight of the hydraulic support systems.

Another prior art design utilizes electric power to drive one electric motor, which turns a climbing nut attached to the moving part of the cylinder. The fixed part is attached to a screw on which the nut rotates and moves with the moving part of the actuator.

There is no provision for continued operation in the event when one part loses function, or if the electric motor fails, thus restricting its use to non-flight-critical applications.

Recent developments of electromechanical actuators (EMA) permit sufficient power densities in fault tolerant designs to be competitive at aircraft level with mature hydraulic technology.

EMA actuators are naturally suited for fly-by-wire systems, but it creates complexity unacceptable for small aircraft that only need a power boost.

Safer and redundant electric system with electromechanical feedback of the boost actuator of the invention does not suffer from the disadvantages of prior art and provides continuous operation if each of one motor or one element fails.

### SUMMARY OF THE INVENTION

Electromechanical boost actuators for aircraft controls can be made more reliable and fault tolerant by adding an independently supported second motor with an independent second control bus power and independent second circuitry.

The two motors are driving two independent ball-nuts which are climbing on a screw-shaft and are supported by four bearings and two brakes, so if one motor fails, it gets locked and the second motor is not locked and continues to drive its climbing ball-nut and the screw-shaft by means of the independent circuitry. The screw-shaft drives a ball-threaded output shaft.

This actuator architecture provides the required redundancy and integrity to allow use of EMA's in aircraft primary flight controls. This mechanism with controls is shown in FIG. 1, and includes a part of feedback mechanism.

The electromechanical feedback mechanism design for position control of the output end of the actuator permits simple function of actuator control system, enabling simple implementation of a controller with no complex management of failure modes. Also, the control system is far less dependent on aircraft dynamics model, reducing NRE cost.

This invention differentiates from related art full function FBW electric actuators, such as described by Umbra Group, in that it functions as a power boost controlled by mechanical motion of the control links initiated by the pilot.

By other words, the boost power of the actuator is added to the control links of the aircraft, based on the feedback of controls position, and is implemented until it reaches the commanded and desired position.

Referring now to the FIG. 2, showing the electromechanical feedback mechanism:

The feedback is obtained by having a pivoting lever with its pivoting pin attached to the fixed part of the actuator with motors via a swing arm, and having a link with one end attached to the lever arm and the other end attached to the moving output shaft of the actuator.

The pivot pin of the lever is suspended on the swing arm, which arm is attached to the fixed part of the actuator, and the position of the swing arm and thus also the lever is sensed by second link going from the lever's pivot pin to a rheostat (or any voltage/position sensing device), as is shown in FIG. 2.

As the actuator moves the output shaft, the second link position is sensed by the rheostat. When pilot initiates the movement of the control link, which is attached to the other end of the lever, the pivot pin will pull the second link going to the rheostat, and also will swing the swing arm. The rheostat will activate the motors to move the output shaft of the actuator via a circuit.

This motion will move the swing arm back to the original position, and the rheostat connected to motor control circuitry will stop the motors. This is accomplished by an independent circuitry for stopping and starting the above described motors shown in FIG. 1.

Thus the pilot's command is implemented by the booster actuator being moved into desired position. This also works in opposite direction on pilot's command.

Another embodiment of the invention is a feedback control mechanism including two secondary electromechanical actuators replacing the feedback link and used to inject a second control signal in the feedback loop in order to control the actuator output simultaneously from the pilot input and from e secondary input such as that generated from an automated aircraft stabilization system.

Another embodiment of the invention is the Electronic Control Circuitry Design of the Feedback System, as shown in FIG. 3.

The Electronic Control Circuitry is composed of two equivalent sections, each controlling one of the motors of the actuator. Each section senses the output of the position transducer measuring the displacement error between the pilot input and the actuator output position and controls the motor to produce an output displacement of direction and magnitude such as to cancel the measured error. This is achieved through a power section which amplifies the control signal and delivers the necessary electric power to the motor in the suitable format.

The principal object of the invention is to provide safer, simpler and lower cost electromechanical boost actuators with electromechanical feedback of aircraft controls.

Another object of the invention is to provide electromechanical boost actuators, which can operate without fly-by-wire systems.

Another object of the invention is to provide electromechanical feedback mechanism for control of the electromechanical aircraft actuators.

Another object is to provide means to control the actuator through a primary and a secondary channel, where the primary is pilot input and the secondary can be the output of an aircraft automatic stabilization system.

Other objects and advantages of the invention will be apparent from the description, drawings and claims.

### DESCRIPTION OF THE DRAWINGS

The nature and characteristic features of the invention will be more readily understood from the following description taken in connection with the accompanying drawing part thereof, in which:

FIG. 1 is a diagrammatic sectional side view of the electromechanical actuator with two independent motors, illustrating its components.

FIG. 2 is a diagrammatic side view of the electromechanical actuator with electromechanical feedback mechanism, illustrating its components.

FIG. 3 is a block diagram illustrating the electric components of the booster actuator feedback mechanism and their redundant architecture.

FIG. 4 is a further depiction of the mechanical part of the feedback system including fault tolerant features.

FIG. 5 is a depiction of the mechanical part of the feedback system of FIG. 4 with the inclusion of additional secondary electromechanical actuators of injection of supplemental controls, such as from an automatic stabilization system.

Like numerals identify the like components in all Figures.

It should of course be understood, that the description and drawings herein are merely illustrative, and that various modifications, combinations and changes can be made in the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents, which operate and function in substantially the same way to bring about the same results.

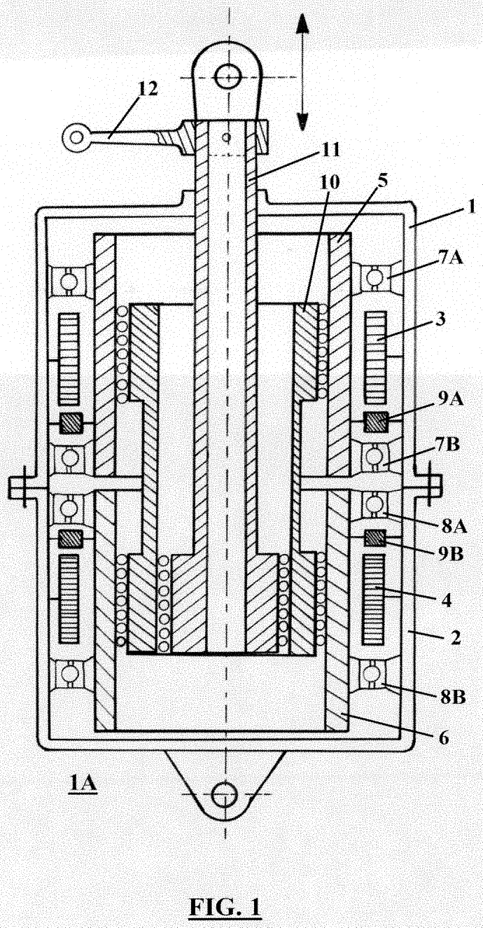

Referring now to the drawing FIG. 1, a preferred redundant electromechanical booster actuator is herein illustrated.

The redundant booster actuator 1A comprises:

Upper housing 1; lower housing 2; electric motor 3; electric motor 4; motor's 3 inner ball nut 5; motor's 4 inner ball nut 6; inner ball nut's 5 bearings 7A and 7B; inner ball nut's 6 bearings 8A and 8B; inner ball nut's 5 electric brake 9A; inner ball nut's 6 electric brake 9B; screw shaft 10; ball treaded output shaft 11; and independent circuitry 21 with feedback electro-mechanism 1B.

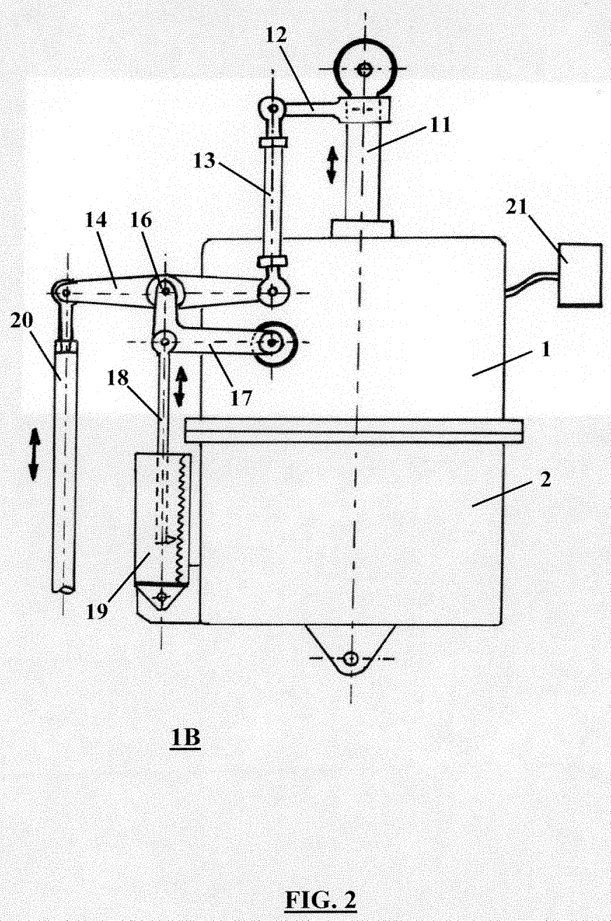

Normally, both electrically and mechanically independent motors 3 and 4 run together, controlled by two independent circuits, driving two inner ball nuts 5 and 6, having opposite ball threads, left and right, which nuts are driving the screw shaft 10, which drives the ball threaded output shaft 11. The ball nuts 5 and 6 are supported by the bearings 7A, 7B and 8A, 8B, and are locked before operation by the electric brakes 9A and 9B. These brakes are unlocked when the motors 3 and 4 are activated by the independent circuitry 21 and by electromechanical feedback electro-mechanism 1B, shown in FIG. 2.

Simplified operation of the booster actuator is as follows:

1. When both motors 3 and 4 drive the two ball nuts 5 and 6 in the same direction at the same speed, screw shaft 10 rotates with the two ball nuts 5 and 6, and the screw shaft translates (=moves).

2. When two electric motors 3 and 4 rotate the two ball nuts 5 and 6 in opposite direction at the same speed, they are counterbalanced and screw shaft 10 translates (moves) together with output shaft 11.

3. If one motor 3 works and the other motor 4 is stopped and its ball nut 6 is braked by the brake 9B: the screw shaft 10 roto-translates and output shaft 11 translate (moves).

4. If one motor 4 works and the other motor 3 is stopped and its ball nut 5 is braked by the brake 9A: the screw shaft 10 roto-translates and output shaft 11 translates (moves).

5. If two motors 3 and 4 rotate two ball nuts 5 and 6 in the same or opposite direction, and rotating speed of the motors 3 and 4 is different, the screw shaft 10 roto-translates and output shaft translates (moves).

6. In emergency mode, if one motor or one electronic circuit fails, the brake of the corresponding ball nut is activated, and the other motor will rotate its ball nut, and the screw shaft 10 will roto-translate (move) carrying along the output shaft 11.

7. If the screw shaft 10 jams with one or both ball nuts, the two motors 3 and 4 are actuated in the same direction and speed, and the screw shaft 10 rotates with both nuts 5 and 6, and the output shaft 11 translates (moves).

Referring now to the drawing FIG. 2, showing a preferred redundant electromechanical feedback mechanism 1B, which is another embodiment of the invention.

The feedback is obtained by having pivoting lever 14 attached to fixed part 1 of the actuator with the motors 3 and 4, and having link's 13 one end attached to the lever 14 and the other end attached to moving output shaft 11 of the actuator by bracket 12.

Pivot pin 16 of the lever 14 is suspended on swing arm 17 attached to the fixed part 1 of the actuator, and position of the swing arm 17 and thus, also the position of the lever 14 is sensed by second link 18 which is going from the lever's 14 pivot pin 16 into rheostat 19 (or any electric/position sensing device), as is shown in FIG. 2.

As the actuator moves the output shaft 11, the second link 18 position is sensed by the rheostat 19. When pilot initiates the movement of control link 20, which is attached to the other end of the lever's 14, the pivot pin 16 will pull the second link 18 going to the rheostat 19, and also will swing the arm 17. The rheostat 19 will then activate the motors 3 and 4 to move the output shaft 11 of the actuator via circuit 21. This motion will move the swing arm 17 back to the original position, and the rheostat 19 electrically connected to the motor circuitry 21 will stop the motors 3 and 4. This is accomplished by an independent circuitry for starting and stopping the above described motors shown in FIG. 1. The circuitry is preferably redundant for safety.

Thus the pilot's command is implemented by the booster actuator being moved into desired position. This also works in opposite direction on pilot's command.

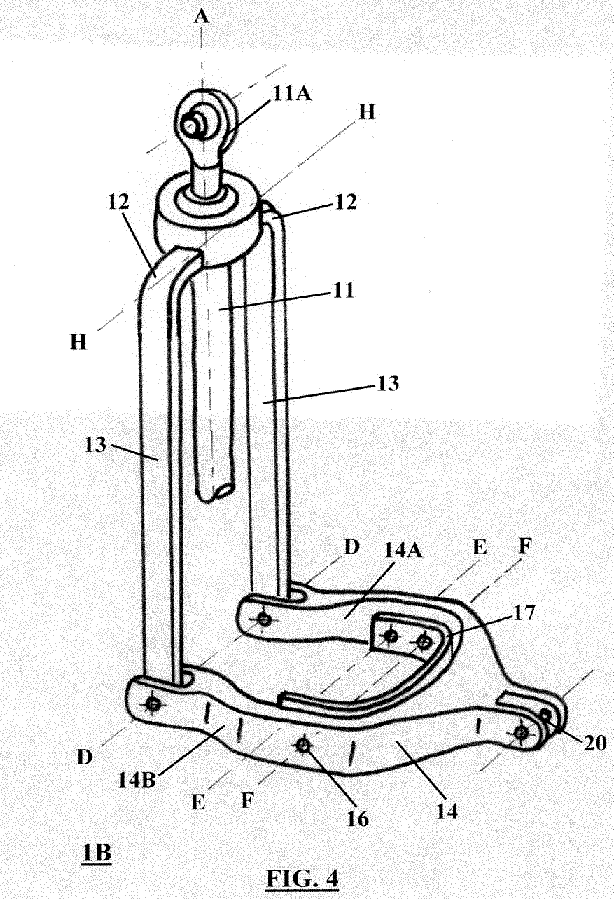

FIG. 4 provides a further clarification of one possible embodiment of the feedback system described in FIG. 2.

It should be understood that the linkages 13 represented in FIG. 2, although shown singly, can be two parallel set installed on opposing lateral sides of the actuator. Lever 14 is substantially U-shaped and comprises a central connection hinged to the control member 20; and two substantially parallel arms on opposite sides of actuator body 1. Each of the arms (14A, 14B) of lever 14 has a free end connected to the bottom end of a respective feedback rod 13 by a hinge along axis D; and rods 13 have respective top ends connected to bracket 12. In this embodiment, the necessary articulation between rods 13, bracket 12 and rod 11 is achieved with a spherical joint, but this does not need to be the only possible implementation, as long as rotation round axis H perpendicular to axis A and parallel to axis D is provided.

Lever 17 is also substantially U-shaped and has two arms on opposite sides of the actuator body 1 and hinged to the actuator body 1. By virtue of the closed-loop structure defined by the input lever 14, The transmission lever 17 and the actuator body 1, two kinematic chains are always available for transmitting control from the control rod 20 to the position transducer rod 18, so that any interruption in either one of the kinematic chains—e.g. failure of an arm on the lever 14 or the lever 17, or of attachment to the actuator body 1 itself—in no way impairs control transmission to the rheostat 19 or the full efficiency of the device 1B.

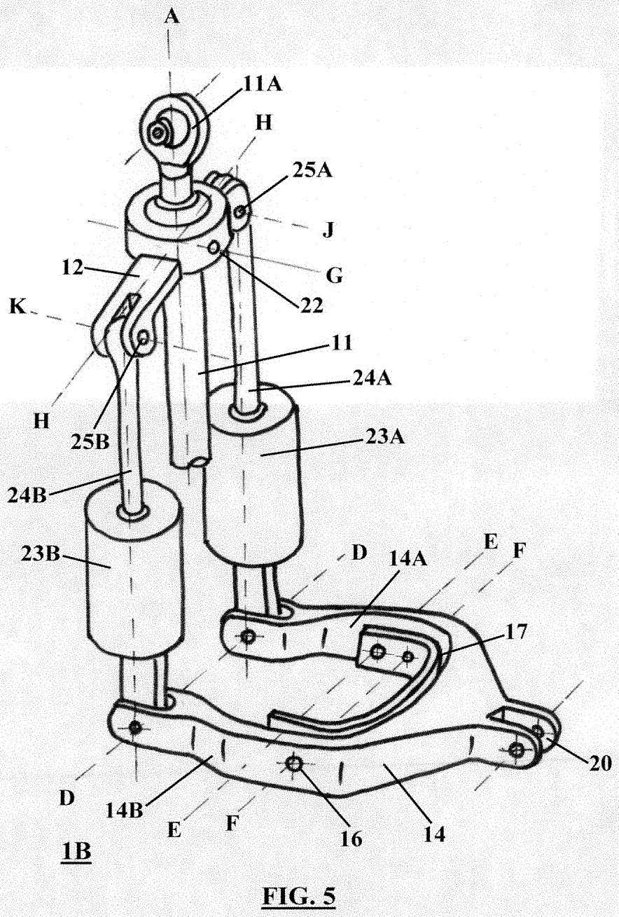

Changes may be made to device 1B without departing from the scope of the invention. In particular, the construction design and constraints of the levers 14, 17 may differ. For example, to enhance the redundancy characteristics of the device, the input lever 14 may be formed in two symmetrical halves (i.e. by “cutting” the lever 17 along symmetry plane), so that any cracks in one half are prevented from spreading to the other. Another embodiment of the invention is described in FIG. 5, where the feedback links 13 are replaced with two electromechanical actuators (23A, 23B) rotably connected at their one end to the lever 14 along axis D with a spherical joint and connected at their other end to the bracket 12 with a spherical joint (25A, 25B). The bracket 12 is connected with the rod 11 through a teetering joint 22 along axis G.

The actuators (23A,23B) can extend and retract their rods (24A, 24B) under control from a separate system such as an aircraft automated stabilization system (not shown).

During normal operation, both actuators extend and retract for the same distance and direction. By doing so, they affect the kinematic chain relationships of the feedback mechanism and thereby modify the equilibrium position of the rheostat 19, changing the output of the actuator without impacting the input. In case of malfunction of one of the actuators (23A,23B), the teetering joint 22 linking the output of the two feedback actuators (23A, 23B) to the tandem actuator movable connection (11) allows operation of the feedback system by controlling the remaining functional actuator (23A or 23B) while the failed one is deactivated in a fixed position. This feature provides the ability to accommodate single actuator lock or runaway failures through differential operation of the two actuators, thereby insuring redundancy without the need of dual architecture for the secondary actuators. Another embodiment of the invention is Electronic Control Circuitry Design of the Feedback System, as is shown in FIG. 3.

The electronic control circuitry of the Electronic Control Unit (ECU) 21 comprises two independent sections, each dedicated to one half of the actuator, hereby identified by the references ECU1 and ECU2. Each section includes a power supply and three separate sub-units identified as COM1, MON1 and INV1 for section ECU1 and COM2, MON2 and INV2 for section ECU2.

The function of the sub-units is the same in each section. The CON unit is used to control the motor, based on the output of the position transducer/rheostat (19), the MON board is in charge of monitoring the System and the INV board receives the motor control signals from the CON board and suitably modulates the motor drive voltages and currents to operate the motor.

The control logic for activation and monitoring of the actuator can be implemented in a number of different technical solutions, with a preference for non-complex systems such as analog circuits or field programmable gate arrays (FPGA).

It will thus be seen, that safer and simpler flight control electromechanical boost actuators' electromechanical feedback systems for aircraft without fly-by-wire flight control systems are herein described, with which the objects of the invention are achieved.

I claim:

1. A feedback mechanism for electromechanical flight control boost actuators with two electric motors, which actuators are not dependent on fly-by-wire systems and have a fixed part body and a moving output shaft, and which feedback mechanism comprising:
a single pivoting lever with two arms, rotably attached to said fixed part body of said actuator by a first pin, suspended on a single swing arm, rotably attached to said fixed part body by a second pivot pin;
a first link with one end connected to one said pivoting lever's arm and other end connected to said actuator's output shaft in a rotable manner;
a second link with one end connected to said swing arm and other end inserted into an electrical position sensing device, such as rheostat, in a rotable manner;
an aircraft control link with one end rotably connected to said pivoting lever's other arm, providing pilot's input into said feedback mechanism; and
an electronic circuitry, electrically connected to said position sensing device and to said electromechanical boost actuator's motors, which circuitry provides boost power to said aircraft controls by said motors.

2. The feedback mechanism for electromechanical flight control boost actuators with two electric motors, as described in claim 1, in which said feedback mechanism has said single pivoting lever replaced by a dual U-shaped pivoting lever, rotably attached to both opposite sides of said fixed part body by two first pivot pins; and has one said first link replaced by two first links on opposite sides of said fixed part body, and connected on their one end to said dual pivoting lever's two arms and other end to said actuator's output shaft in rotable manner; and
in which said single swing arm attached to said fixed part body by said second pivot pin is replaced by a dual U-shaped swing arm, rotably attached to both opposite sides of said fixed part body by two second pivot pins, and is connected by said second link to said position sensing device in rotable manner; and
in which said dual U-shaped pivoting lever has one other arm rotably connected to said aircraft control link.

3. The feedback mechanism for electromechanical flight boost actuators with two independent motors, as described in claim 2, in which said feedback mechanism has said two first links on opposite sides of said fixed part body of said actuator replaced by two second electromechanical actuators, connected at their one end to said dual pivoting lever's two arms, and at their other end to said output shaft via a bracket with two spherical joints, and a teetering joint on said output shaft; and
in which said two second actuators are controlled by a second separate system, such as an aircraft automated stabilization system.

4. A redundant electromechanical flight control boost actuator with two independent electric motor systems, which actuator is not dependent on fly-by-wire systems, and which is controlled by said feedback mechanism as described in claim 1.

5. A redundant electromechanical flight control boost actuator with two independent electric motor systems, which is not dependent on fly-by-wire systems, and which is controlled by feedback mechanism as described in claim 2.

6. A redundant electromechanical flight control boost actuator with two independent electric motor systems, which is not dependent on fly-by-wire systems, and which is controlled by feedback mechanism as described in claim 3.

7. An electronic circuitry for control of said actuator described in claim 4, which circuitry has two independent sections, each dedicated to one motor system, and in which each section includes a power supply and three separate units identified as:
motor control based on said position sensing device; monitoring system; and power module.
